(19) United States
(12) Patent Application Publication
(10) Pub. No.: US 2024/0017553 A1
(43) Pub. Date: Jan. 18, 2024

(54) EMPTY DETERMINATION FOR PRINTING AGENT RESERVOIRS BASED ON MOTOR WORK PARAMETER

(71) Applicant: HEWLETT-PACKARD DEVELOPMENT COMPANY, L.P., Spring, TX (US)

(72) Inventors: Russell Sterling SAUER, Vancouver, WA (US); Jeffrey A. WAGNER, Vancouver, WA (US)

(21) Appl. No.: 17/867,400

(22) Filed: Jul. 18, 2022

(51) Int. Cl. B41J 2/175; B41J 2/045

(52) U.S. Cl. CPC B41J 2/17566; B41J 2/04501; B41J 2002/17569

(57) ABSTRACT

An example printing device includes a plurality of printing agent reservoirs and a printing assembly that is to emit printing agent onto print media. In addition, the printing device includes a pumping assembly fluidly coupled between the plurality of printing agent reservoirs and the printing assembly. The pumping assembly includes a motor and is to transport the printing agent from the plurality of printing agent reservoirs to the printing assembly. Further, the printing device includes a controller coupled to the motor. The controller is to: receive a work parameter of the motor; receive printing agent usage data; and determine that a first printing agent reservoir of the plurality of printing agent reservoirs is empty based on the work parameter and the printing agent usage data.

### BACKGROUND

A printing device may deposit a printing agent (e.g., a liquid printing agent such as ink) on a piece of print media to form an image. Printing agent may be stored within reservoirs that are fluidly coupled to a printing assembly within the printing device. During operations, the printing agent is flowed from the reservoirs to the printing assembly, and then the printing assembly deposits the printing agent on the print media at desired locations.

### BRIEF DESCRIPTION OF THE DRAWINGS

Various examples will be described below referring to the following figures:

FIG. 1 is a schematic diagram of a printing device that is to determine a printing agent reservoir is empty based on a work parameter according to some examples;

FIG. 2 is a block diagram of a controller of the printing device of FIG. 1 according to some examples;

FIG. 3 is a plot showing changes in a pulse width modulation (PWM) signal magnitude for a pump motor showing characteristic changes that may indicate a printing agent reservoir is empty according to some examples;

FIGS. 4 and 5 are schematic diagrams of a printing agent reservoir according to some examples; and

FIGS. 6 and 7 are flow diagrams of methods of detecting that a printing agent reservoir of a printing device is empty according to some examples.

### DETAILED DESCRIPTION

A printing device may deposit a printing agent on print media to form an image. As used herein, an image that may be formed on print media by a printing device may include, among other things, text, graphics, photographs, works of art, or some combination thereof. In addition, as used herein, “print media” may include any surface or object that may receive printing agent thereon for forming an image. For instance, “print media” may include paper, cardboard, or other sheets or panels of material.

In addition, the term “printing agent” may include any suitable agent that may be used to form images during a printing operation. For example, a “printing agent” may include a liquid printing agent such as ink, as well as a clear liquid (e.g., as a base coat or top coat for a printed image). In some examples, a printing agent may include a fluid or solid (e.g., powder) that is used for printing a three-dimensional (3D) object via additive manufacturing (e.g., 3D printing).

During operations, a reservoir of printing agent may exhaust is stored volume of printing agent and thus run empty. In these instances, the printing device may not be able to complete a requested printing job. In addition, an empty printing agent reservoir may cause additional stress and wear on components of the printing device. For instance, a pump that is to flow the printing agent from the reservoir to the printing assembly may draw a vacuum or may lose prime, which may damage the pump or at the least degrade its performance. In some circumstances, the interruption in the supply of printing agent resulting from an empty printing agent reservoir may cause damage to the printing assembly of the printing device.

Accordingly, example printing devices and related methods are disclosed herein for detecting that a printing agent reservoir for a printing device is empty. In some examples, detecting that the printing agent reservoir is empty may be accomplished by monitoring a work parameter (defined and discussed in more detail below) of a motor driving a pump for flowing printing agent from the printing agent reservoir. Additional printing agent usage data may also be obtained that further allow the empty printing agent reservoir to be specifically identified so that further remedial procedures may be performed. Thus, through use of the examples disclosed herein, a printing device may avoid operating with an empty printing agent reservoir, thereby also avoiding degradation of printing performance and premature wearing of the components of the printing device.

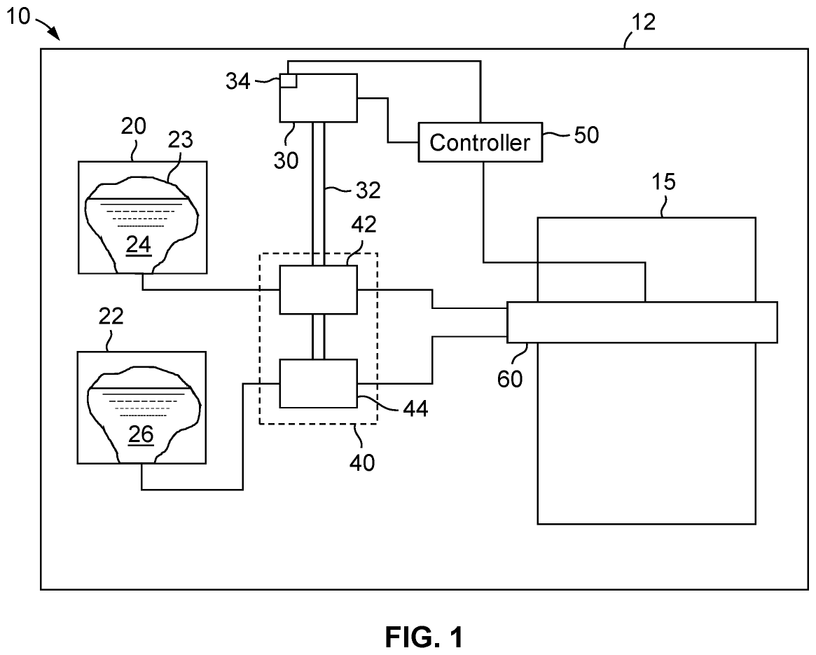

Referring now to FIG. 1, a printing device 10 according to some examples is shown. Printing device 10 includes a housing 12. In addition, the printing device 10 includes a plurality of printing agent reservoirs 20, 22, a pumping assembly 40, and a printing assembly 60. During operations, the printing device 10 may form images on print media 15 by depositing printing agent (e.g., printing agent 24, 26) on the print media 15 with the printing assembly 60. The printing agent may be flowed to the printing assembly 60 in parallel from the plurality of print fluid reservoirs 20, 22 via the pumping assembly 40. Further details of printing device 10 and the components thereof is now provided below.

The plurality of printing agent reservoirs 20, 22 may be positioned within the housing 12. In some examples, the plurality of printing agent reservoirs 20, 22 may be positioned outside of housing 12 and are fluidly coupled (e.g., via a tube, pipe, or other conveyance device) to components that are positioned within the housing 12 (e.g., pumping assembly 40, printing assembly 60 as described in more detail herein). The plurality of printing agent reservoirs 20, 22 may each comprise any suitable tank, cartridge, or other vessel that is to hold a volume of printing agent (e.g., liquid printing agent) therein. In some examples, the plurality of printing agent reservoirs 20, 22 may each comprise a bladder 23 or may comprise a tank with a membrane positioned therein that is to separate the printing agent from ambient pressure that is outside of the printing agent reservoirs 20, 22. During operations, the bladder 23 may expand and contract as the volume of printing agent changes within the printing agent reservoirs 20, 22.

In some examples, the plurality of printing agent reservoirs 20, 22 comprise a first printing agent reservoir 20 and a second printing agent reservoir 22. While two printing agent reservoirs (e.g., first printing agent reservoir 20 and second printing agent reservoir 22) are shown in FIG. 1, in other particular examples, different numbers of printing agent reservoirs (e.g., such as more or less than two) may be included within (or coupled to) housing 12 of printing device 10. The first printing agent reservoir 20 may hold or contain a first printing agent 24, and the second printing agent reservoir 22 may hold or contain a second printing agent 26. The first printing agent 24 may be different from the second printing agent 26. For instance, the first printing agent 24 may be a different color than the second printing agent 26. In some examples, the first printing agent 24 may be utilized to form images on print media 15 and the second printing agent 26 may comprise a top coat (e.g., a clear coat) that is to protect the image formed by the first printing agent 24 or a base coat that is to condition the print media 15 to receive the first printing agent 24 for forming the image.

Referring still to FIG. 1, the pumping assembly 40 may comprise a plurality of pumps (or pumping units) 42, 44 that are each coupled to a corresponding one of the printing agent reservoirs 20, 22. Thus, the number of pumps 42, 44 may correspond with (e.g., equal) the number of printing agent reservoirs 20, 22 in some examples. Accordingly, in the example of FIG. 1, the plurality of pumps 42, 44 of the pumping assembly 40 includes a first pump 42 and a second pump 44. The first pump 42 is fluidly coupled to the first printing agent reservoir 20, and the second pump 44 is fluidly coupled to the second printing agent reservoir 22.

The first pump 42 and the second pump 44 may be driven or actuated by a common motor 30. The motor 30 may comprise an electric motor that is to actuate (e.g., rotate) a shaft 32 when energized with electric current. The shaft 32 may be operatively coupled to both the first pump 42 and the second pump 44 (e.g., via a suitable transmission) such that when motor 30 actuates shaft 32, the first pump 42 and the second pump 44 are both to flow fluid from the first printing agent reservoir 20 and the second printing agent reservoir 22, respectively, to the printing assembly 60. In some examples, the first pump 42 and the second pump 44 may comprise positive displacement pumps, centrifugal pumps, screw pumps, or some combination thereof.

Printing assembly 60 may comprise any suitable device or collection of devices for emitting printing agent onto the print media 15 to form images thereon. In some examples, the printing assembly 60 may comprise a print bar having a plurality of nozzles that are to emit the printing agent during operations. In some examples, the printing assembly 60 may comprise a movable printhead that includes a plurality of nozzles. During operations, the printhead may be moved about the print media 15 (e.g., such as transversely across the print media 15) and actuated to emit printing agent from the plurality of nozzles. Regardless of the particular form of printing assembly 60, during operations, the printing assembly 60 may receive the printing agent from the printing agent reservoirs 20, 22 via the pumps 42, 44, respectively, as previously described.

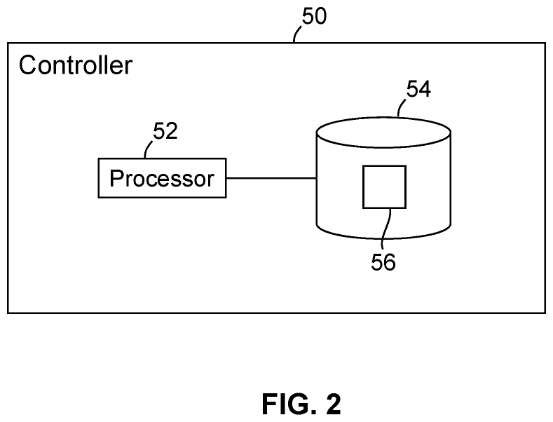

Referring still to FIG. 1, a controller 50 may be coupled to the motor 30. In the example of FIG. 1, the controller 50 may be positioned within the housing 12; however, in other examples, controller 50 (or a portion thereof) may be positioned outside and separate from the housing 12. Referring now to FIG. 2, the controller 50 includes a processor 52 and a memory 54 coupled to the processor 52.

The processor 52 may comprise any suitable processing device, such as a microcontroller, central processing unit (CPU), graphics processing unit (GPU), timing controller (TCON), scaler unit. The processor 52 executes machine-readable instructions (e.g., machine-readable instructions 56) stored on memory 54, thereby causing the processor 52 to perform some or all of the actions attributed herein to the controller 50. In general, processor 52 fetches, decodes, and executes instructions (e.g., machine-readable instructions 56). In addition, processor 52 may also perform other actions, such as, making determinations, detecting conditions or values, etc., and communicating signals. If processor 52 assists another component in performing a function, then processor 52 may be said to cause the component to perform the function.

The memory 54 may comprise volatile storage (e.g., random access memory (RAM)), non-volatile storage (e.g., flash storage, etc.), or combinations of both volatile and non-volatile storage. Data read or written by the processor 52 when executing machine-readable instructions 56 can also be stored on memory 54. Memory 54 may comprise “non-transitory machine-readable medium,” where the term “non-transitory” does not encompass transitory propagating signals.

The processor 52 may comprise one processing device or a plurality of processing devices that are distributed within printing device 10. Likewise, the memory 54 may comprise one memory device or a plurality of memory devices that are distributed within the printing device 10. In some examples, the controller 50 may be the general controller of the printing device 10 that directs all functionality of the printing device 10 during operations. In some examples, the controller 50 may be separate from a general controller of the printing device 10 that controls a sub-set of the functionality of the printing device 10 during operations (e.g., such as the specific functionality described herein). To simplify the description herein, the controller 50 will be described as being the general controller of the printing device 10.

Referring again to FIG. 1, during operations, the controller 50 may monitor a work parameter of to the motor 30 to determine when one or both of the printing agent reservoirs 20, 22 is empty or nearly empty. As used herein, a work parameter of the motor 30 refers to any value or collection of values that are descriptive or indicative of the work being performed by motor 30 during operations. “Work” refers to the force (F) output by the motor 30 multiplied by the physical displacement of the motor 30 associated with the force output. For the motor 30, the physical displacement refers to a rotation of the shaft 32, and thus the force output F is characterized by an output torque (\vec{T}).

A mathematical description of the work W performed by the motor 30 is shown in Equation (1) below:

W=\vec{T}×θ (1)

In Equation (1) above, W is the work performed by motor 30, T is the output torque (which is borne by the shaft 32), and 0 is the rotational displacement of the shaft 32 in radians. Various values and parameters of the motor 30 are indicative of the work performed by motor 30 (W in Equation (1) above). For instance, work W of motor 30 can be directly related (e.g., proportional) to the output torque (e.g., via Equation (1)), the input voltage or electrical current to the motor 30, the rotational speed of the motor 30, power output of the motor 30 (e.g., in horse power (HP)), etc. Thus, a “work parameter” of motor 30 may comprise the work W itself, the output torque, input voltage, input electrical current, the rotational speed, power output, or some combination thereof.

The input voltage to the motor 30 may be controlled via controller 50 or another controller or processor of the printing device 10. For instance, the input voltage to the motor 30 may be controlled via a pulse width modulation (PWM) signal. Generally speaking, a PWM signal comprises a series of pulses of electric current to the motor 30 over a frequency. Thus, a PWM signal may comprise a square wave pattern whereby voltage oscillates between zero and a maximum value. The time duration of the pulses may be adjusted so as to approximate an average input voltage between zero and the maximum value. Specifically, as the time duration of the pulses is increased, the average input voltage applied to the motor 30 also increases toward the maximum value. As used herein, the time duration of the voltage pulses within the PWM signal may be referred to herein as the magnitude of the PWM signal. Thus, as the time duration of the pulses of the PWM signal increase, the magnitude of the PWM signal increases. In addition, references herein to a change (including an increase or decrease) in a PWM signal refer to a change (including an increase or decrease) of the magnitude of the PWM signal.

The output speed of the motor 30 (e.g., the rotational speed of the shaft 32) may be directly related to the input voltage (and thus also the magnitude of the PWM signal). Thus, as the input voltage is increased (via an increase of the PWM signal as previously described), the output speed of the motor 30 is also increased. Accordingly, the PWM signal and changes therein may also be a “work parameter” of the motor 30 as used herein.

During operations, the speed of the motor 30 may be selected based on a printing operation to be performed. Thus, the controller 50 may adjust an input voltage to the motor 30 (e.g., via adjustments to the PWM signal) to a predetermined value that is to result in the desired speed of the motor 30. An encoder 34 coupled to or incorporated within the motor 30 may measure or detect the actual output speed of the motor 30 (e.g., again a rotational speed of the shaft 32) and may provide a suitable output signal that is indicative of the measured output speed of the motor 30 to the controller 50. If an actual speed of the motor 30, as measured by the encoder 34, is different from a selected speed associated with the input voltage to the motor 30, the controller 50 may automatically adjust the input voltage to the motor 30 to reduce the difference (e.g., between the desired and actual output speed of the motor 30) and provide an output speed of the motor 30 that matches (or substantially matches) the desired rotational speed. As previously described, the controller 50 may adjust the input voltage to the motor 30 via adjustments to the PWM signal to motor 30.

During operations, the controller 50 may monitor for changes in a work parameter of the motor 30 that would indicate that a printing agent reservoir 20, 22 (or multiple printing agent reservoirs 20, 22) are empty or close to empty. For instance, the controller 50 may monitor the input voltage to the motor 30 (e.g., via the PWM signal as previously described) for characteristic increases and decreases (described in more detail below) that may be associated with speed adjustments to the motor 30 based on a changing load (e.g., pressure load, inertial load, etc.) to the motor 30 caused by a depleted supply of printing agent 24, 26 in a printing agent reservoir 20, 22. If the controller 50 determines that a printing agent reservoir 20, 22 is empty (or substantially empty) via the work parameter, the controller 50 may receive printing agent usage data of the printing device 10 to identify which one or ones of the printing agent reservoirs 20, 22 are empty. Because the input voltage of the motor 30 is related (and potentially even proportional) to other work parameters of the motor 30 (e.g., Torque, input current, work, etc.) in some examples, controller 50 may monitor one or a plurality of these other “work parameter for corresponding characteristic changes that would indicate that a printing agent reservoir 20, 22 or multiple printing agent reservoirs 20, 22 are empty. Thus, while some of the discussion herein focuses on analysis of input voltage (or PWM signal) to the motor 30 to determine when a printing agent reservoir is empty, other systems may monitor other work parameters to the same ends according to the various examples disclosed herein.

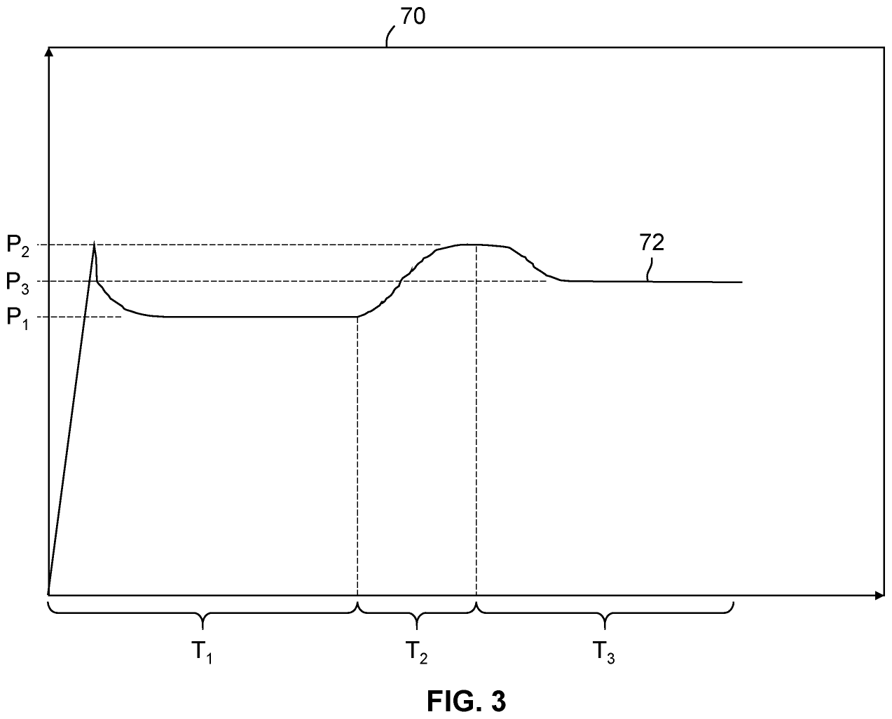

FIG. 3 shows a plot 70 of the PWM signal 72 of motor 30 over time while printing agent 24, 26 is being delivered to printing assembly 60 from printing agent reservoirs 20, 22 via pumps 42, 44, respectively. In describing plot 70, continuing reference is made to the printing device 10 shown in FIG. 1.

The plot 70 illustrates the changes in the PWM signal 72 that may be associated with a printing agent reservoir 20, 22 becoming empty or substantially empty according to some examples. Plot 70 illustrates a plurality of successive time periods T₁, T₂, T₃ that occur sequentially one after the other starting with T₁, followed by T₂, and finally concluding with T₃.

The initial time period T₁ includes an initial operation of the motor 30, such as during a printing operation with printing device 10 (FIG. 1). When the motor 30 is first activated or turned on (e.g., at the beginning of a printing operation), there may be a spike in the input voltage (and thus also the PWM signal 72) that is associated with the high initial load borne by the motor 30 to initiate rotation of the shaft 32. Thereafter, the PWM signal 72 may reach a steady state or nominal value P₁ (which corresponds to a nominal input voltage). The nominal value P₁ may be associated with pumping printing agent 24, 26 to the printing assembly 60 via the pumping assembly 40 at a relatively constant flow rate. During this steady state operation, the PWM signal 72 may actually fluctuate within some margin due to noise or other non-steady conditions or variations (e.g., fluctuations in the printing agent 24, 26 flowing through pumps 42, 44, fluctuations in the electric current supply for printing device 10, etc.). These steady state fluctuations of the PWM signal 72 may be within a noise margin such that the average value of the PWM signal 72 over time period T₁ is taken as the nominal value P₁.

As the level of the printing agent 24, 26 within a printing agent reservoir 20, 22 approaches empty, the suction head pressure experienced by the corresponding pump 42, 44 of the pumping assembly 40 may decrease such that a load placed on the shaft 32 increases to slow the speed of motor 30. Specifically, as the volume of printing agent 24, 26 decreases within the corresponding printing agent reservoir 20, 22, the respective pump 42, 44 is forced to draw in printing agent 24, 26 that resides in corners, folds or other less accessible regions of the bladder 23. The controller 50 may compensate for this increased load by increasing the PWM signal 72 via the controller 50 to maintain the desired speed as previously described. This increase in the PWM signal 72 is shown during time period T₂ as an increase from the nominal value P₁ to a second value P₂. The increase from P₁ to P₂ may be substantial enough so as to be distinguishable from noise or other variances of the PWM signal 72 during normal operation previously described above.

Once the printing agent 24, 26 is fully depleted from the printing agent reservoir 20, 22, respectively, the increased load on the shaft 32 via the corresponding pump 42, 44 may decrease such that the speed of the motor 30 may increase. Specifically, when the bladder 23 of the corresponding printing agent reservoir 20,22 runs completely empty, the flow of printing agent 24, 26 out of the bladder 23 ceases, and a vacuum is created that ultimately causes the bladder 23 to collapse. The volume reduction due to the collapse of the bladder 23 reduces a load on the motor 30 via the shaft 32 and corresponding pump 42, 44, from a maximum value associated with P₂ of PWM signal 72. The controller 50 may respond to this decreased load by decreasing the PWM signal 72 to maintain the desired speed of motor 30 as previously described. Thus, in time period T₃, the PWM signal 72 may show this characteristic decrease from the local maximum value at P₂ down to P₃. In some examples, P₃ may be greater than P₁ but less than P₂.

The decrease in the PWM signal magnitude to P₂ during time period T₃ may then be followed by a period of relative stability in the PWM signal magnitude T₃ given that the load on the pumping assembly 40 and motor 30 is no longer changing. Specifically, once the bladder 23 of the empty printing agent reservoir 20, 22 is collapsed (or is at its most collapsed state), the load on the motor 30 via the pumping assembly 40 and shaft 32 stabilizes, albeit at a higher level than during the period T₁ when PWM signal 72 was set at the nominal value P₁.

During these operations, the controller 50 may monitor the PWM signal magnitude throughout the time periods T₁, T₂, T₃. If the controller 50 detects the characteristic increase of the PWM signal magnitude (e.g., from P₁ to P₂ in time period T₂), followed by the characteristic decrease of the PWM signal magnitude (e.g., from P₂ to P₃ in time period T₃), the controller 50 may determine that a printing agent reservoir 20, 22 or multiple printing agent reservoirs 20, 22 are empty.

Specifically, once the nominal value P₁ of the PWM signal 72 is established, the controller 50 may monitor for a meaningful increase in the PWM signal 72 that would indicate a printing agent reservoir 20, 22 or multiple printing agent reservoirs 20, 22 are nearly empty, such as the increase of the PWM signal 72 from P₁ to P₂. In some examples, the controller 50 may compare a detected increase in the PWM signal 72 to a threshold to determine if the increase is significant enough to indicate that a printing agent reservoir 20, 22 is nearly empty. In some examples, the threshold may be defined as a percentage change of the PWM signal 72 from the nominal value P₁, such as a 1% to 5% change in some examples. In some examples, controller 50 may compare the increase of the PWM signal 72 (e.g., the increase of T₂ in FIG. 3) to multiple thresholds, whereby an increase that is greater than a second, higher threshold may indicate that multiple printing agent reservoirs 20, 22 are nearly empty at the same time. Thus, in some examples, the controller 50 determines that one of the printing agent reservoirs 20, 22 may be empty if an observed increase in the PWM signal 72 is above a first threshold, and may determine that both of the printing agent reservoirs 20, 22 may be empty is the increase in the PWM signal 72 is above a second threshold that is greater than the first threshold.

Once the controller 50 detects an increase in the PWM signal 72 (that would indicate that a printing agent reservoir 20, 22 is nearing an empty state (e.g., the increase from P₁ to P₂ during time period T₂ in FIG. 3), the controller 50 may then monitor the PWM signal 72 for a period of time (e.g., about 10 to about 30 seconds, or about 15 to about 20 seconds in some examples) for a decrease from the local maximum value at P₂ to a lower steady state value (e.g., P₃ in FIG. 3). As previously described, the decrease from P₂ to P₃ may indicate that a printing agent reservoir 20, 22 has been totally depleted such that the resulting load on the motor 30 reduces to a new steady state condition (with PWM signal settling at P₃). In some circumstances, an increase in the PWM signal 72 that is not followed by the characteristic decrease (e.g., P₂ to P₃) may indicate other issues within the printing device 10 (e.g., a blockage in the pumping assembly 40, damage to the pumping assembly 40 or motor 30, etc.). However, as described in more detail below, a reduced back pressure on a downstream side of pumping assembly 40 (e.g., due to a high output flow of printing agent 24, 26 from printing assembly 60) may prevent the reduction in the PWM signal 72 as shown in FIG. 3 from P₂ to P₃. Thus, in these circumstances, the controller 50 may also determine if a special printing condition (e.g., a high flow volume of printing agent 24, 26 from printing assembly 60) that would alter the characteristic response of the PWM signal 72 when a printing agent reservoir 20, 22 is empty. If such a special printing condition exists, then the controller 50 may still determine that a printing agent reservoir 20, 22 is empty even if a decrease from P₂ is not observed as shown in FIG. 3.

To further determine which one or ones of the printing agent reservoirs 20, 22 are empty, the controller 50 may receive additional printing agent usage data. The printing agent usage data may comprise an estimate of the amount of the printing agent 24, 26 used for printing operations over a period of time. For instance, in some examples, controller 50 may monitor the amount of printing agents 24, 26 that are emitted from printing assembly 60 based on the control signals for completing a printing operation. Specifically, for each printing operation using printing device 10, controller 50 may determine a number of drops of each type of printing agent 24, 26 to form the desired image on the print media 15. Each drop of printing agent 24, 26 may be associated with an average volume so that this information may be utilized to estimate how much of each printing agent 24, 26 has been utilized from the printing agent reservoirs 20, 22, respectively. However, the printing assembly 60 may not emit drops of printing agent in a consistent volume, or may not reliably emit drops of printing agent at all. Thus, the actual number of drops and the total volume of emitted drops of printing agent 24, 26 emitted from printing assembly 60 may differ from the estimated printing agent usage data. As a result, the printing agent usage data may not be relied upon solely to determine when a printing agent reservoir 20, 22 is empty.

However, once controller 50 has determined that a printing agent reservoir 20, 22 or multiple printing agent reservoirs 20, 22 are empty based on the changes in the work parameter of the motor 30 over time as previously described, the printing agent usage data may be informative to determine which one or ones of the printing agent reservoirs 20, 22 are likely to be empty. Specifically, if the work parameter of the motor 30 (e.g., the PWM signal 72) indicates that one of the printing agent reservoirs 20, 22 is empty (e.g., based on the increases and decreases as previously described), the printing agent usage data may then be queried by controller 50 to see which of the two printing agent reservoirs 20, 22 is closest to an empty condition. For example, if the printing agent usage data indicates that the first printing agent reservoir 20 is at 10% capacity while the second printing agent reservoir is at a 60% capacity, the controller 50 may determine that the first printing agent reservoir 20 is most likely to be the printing agent reservoir that is empty. Thus, in these examples, the printing agent usage data is used to verify which printing agent reservoir 20, 22 is empty, and is not relied upon for initially detecting the empty condition in the first place. As a result, the lack of accuracy from the printing agent usage data may be mitigated.

After a printing agent reservoir or multiple printing agent reservoirs (e.g., printing agent reservoirs 20, 22) are identified as being empty, controller 50 may initiate remedial actions to avoid damage to the printing device 10 or the components thereof (e.g., pumping assembly 40, motor 30, printing assembly 60, etc.). For instance, in some examples, controller 50 may stop a printing operation (or may output a signal to another controller or processor to stop a printing operation). In some examples, printing device 10 may immediately stop a printing operation upon a determination that a printing agent reservoir 20, 22 is empty. Alternatively, in some examples, printing device 10 may complete or partially complete (e.g., by completing the current page) a printing operation after an empty printing agent reservoir 20, 22 is detected.

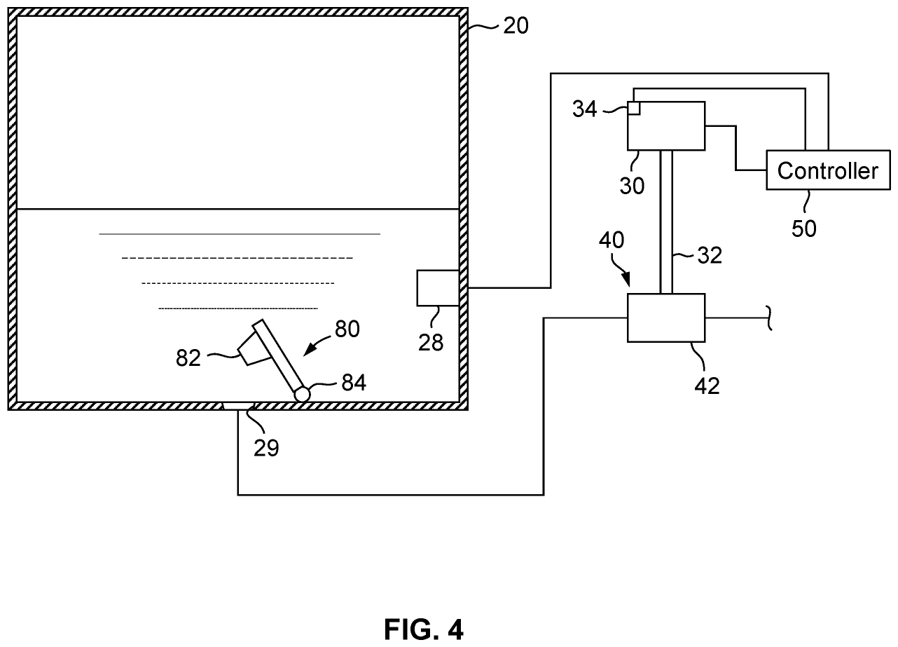

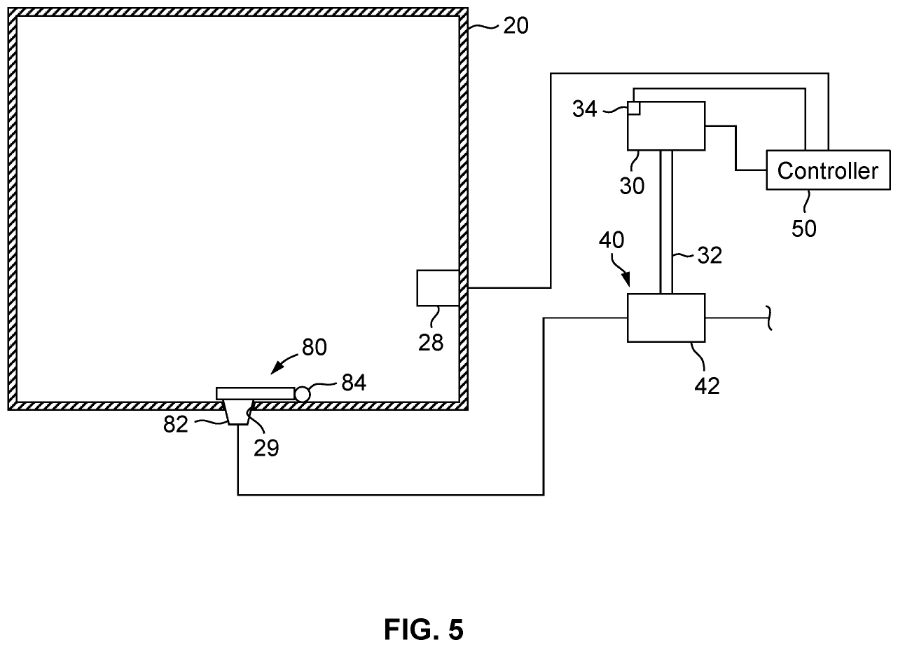

The printing agent usage data may comprise other sources of information or data that are different and separate from the droplet usage data of the printing assembly 60. For instance, referring now to FIGS. 4 and 5, in some examples, printing agent reservoirs 20, 22 may include level sensors 28 that are to determine whether printing agent 24, 26 has fallen below some minimum value within the printing agent reservoirs 20, 22. FIGS. 4 and 5 depict first printing agent reservoir 20 for simplicity.

Specifically, as shown in FIGS. 4 and 5, first printing agent reservoir 20 may include a level sensor 28 that is positioned so as to detect when first printing agent 24 has fallen below some threshold or minimum level (e.g., such as below 10%, 5%, etc. capacity). Level sensor 28 may comprise any suitable sensor (e.g., conductivity sensor, optical sensor, etc.) for detecting whether the level of the first printing agent 24 is above or below the level sensor 28 within first printing agent reservoir 20. The output from level sensor 28 may be communicated to controller 50.

During operations, the output from the level sensor(s) 28 within the printing agent reservoirs 20, 22 may comprise printing agent usage data. Specifically, if the work parameter of the motor 30 (e.g., the PWM signal 72) is indicating that one of the printing agent reservoirs 20, 22 is empty (e.g., based on the increases and decreases as previously described), the controller 50 may look to see which one or ones of the printing agent reservoirs 20, 22 are showing levels below that of the level sensors 28. The printing agent reservoir or reservoirs 20, 22 in which the printing agent 24, 26, respectively, are below level sensor 28 (which may be identified via the output signal of the level sensors 28) may be identified as the printing agent reservoir or reservoirs 20, 22 that are empty.

Referring still to FIGS. 4 and 5, in some examples, a floating stopper assembly 80 may be positioned within the printing agent reservoirs 20, 22 that may automatically close an outlet 29 of the printing agent reservoir 20 when it is empty. In particular, in some examples, the floating stopper assembly 80 includes a stopper 82 that is pivotably coupled proximate to the outlet 29 via a hinge 84. The floating stopper 82 may have sufficient buoyancy within the printing agent 24 so that the floating stopper 82 is rotated away from the outlet 29 as long as it is immersed within the printing agent 24. However, when the printing agent 24 is fully expelled or nearly fully expelled from the printing agent reservoir 20, the floating stopper 82 may rotate about hinge 84 to cover the outlet 29.

Without being limited to this or any other theory, by physically closing the opening, by covering the outlet 29, the changes in the load on the motor 30 that are associated with an empty condition of the printing agent reservoir 20, 22 as previously described above are more pronounced. As a result, the increases may be more easily identifiable from noise or other signal variations. Accordingly, through use of the floating stopper assembly 80, the controller 50 may more accurately detect that a printing agent reservoir 20, 22 is empty via the motor work parameter.

In some examples, the floating stopper assembly 80 may generate a sufficient vacuum upstream of the pumping assembly 40 when the printing agent reservoir 20, 22 runs empty to thereby cause the characteristic changes in the motor work parameter described above, even when the printing agent reservoir 20, 22 is open to atmosphere (e.g., in circumstances where the printing agent reservoirs 20, 22 lack a bladder 23 as shown in FIG. 1). Thus, the floating stopper assembly 80 may be used for examples of printing device 10 that employ refillable printing agent reservoirs.

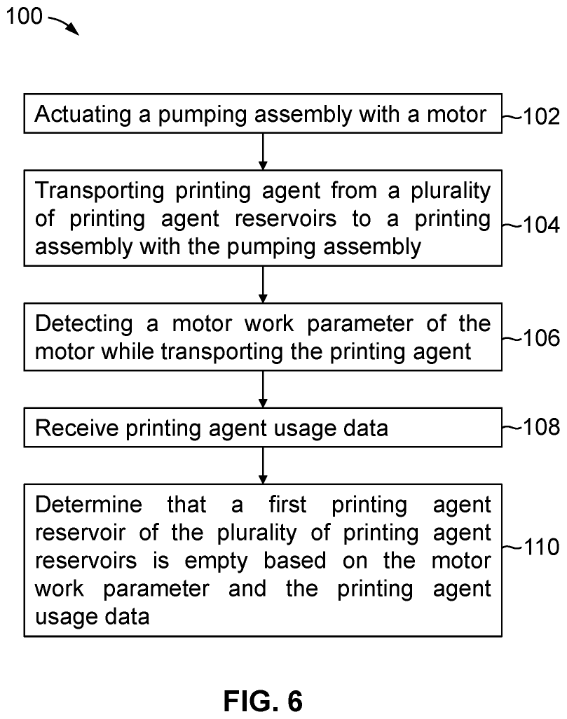

Referring now to FIG. 6, a method 100 of detecting that a printing agent reservoir of a printing device is empty is shown according to some examples. In some examples, the method 100 may be practiced using the printing device 10 previously described above. Thus, in describing the features of method 100 in FIG. 6, continuing reference is made to FIGS. 1-5. However, in some examples, method 100 may be practiced with printing devices that are different from the printing device 10 described herein.

Initially, method 100 includes actuating a pumping assembly with a motor at block 102, and transporting printing agent from a plurality of printing agent reservoirs to a printing assembly with the pumping assembly at block 104. For instance, as described above for the printing device 10 shown in FIG. 1, the motor 30 actuates a plurality of pumps 42, 44 of a pumping assembly 40 to flow printing agent 24, 26 from a plurality of printing agent reservoirs 20, 22, respectively, to a printing assembly 60.

Referring again to FIG. 6, method 100 also includes detecting a motor work parameter of the motor while transporting the printing agent at block 106. The motor work parameter may be as described above, and thus may comprise any value or collection of values that are descriptive or indicative of the work being performed by the motor, such as, for instance, work performed by the motor, the output torque of the motor, the input voltage for the motor, the input electrical current for the motor, the PWM signal (e.g., the PWM signal magnitude) for the motor, the rotational speed of the motor, the power output for the motor, or some combination thereof.

Method 100 also includes receiving printing agent usage data at block 108. As previously described, printing agent usage data may comprise an estimate of a remaining amount of fluid within a printing agent reservoir based on usage and/or other sensor data that is separate from the motor work parameter. For instance, in some examples, the printing agent usage data may comprise a usage estimate based on the parameters of a printing operation or multiple printing operations performed by the printing device. In some examples, the printing agent usage data may comprise an output from a level sensor within a printing agent reservoir (e.g., such as level sensor 28 as previously described).

Next, method 100 includes determining that a first printing agent reservoir of the plurality of printing agent reservoirs is empty based on the motor work parameter and the printing agent usage data at block 110. For instance, the determination that a first printing agent reservoir is empty based on the motor work parameter and the printing agent usage data may be made in the manner previously described above for controller 50 of printing device 10 in some examples.

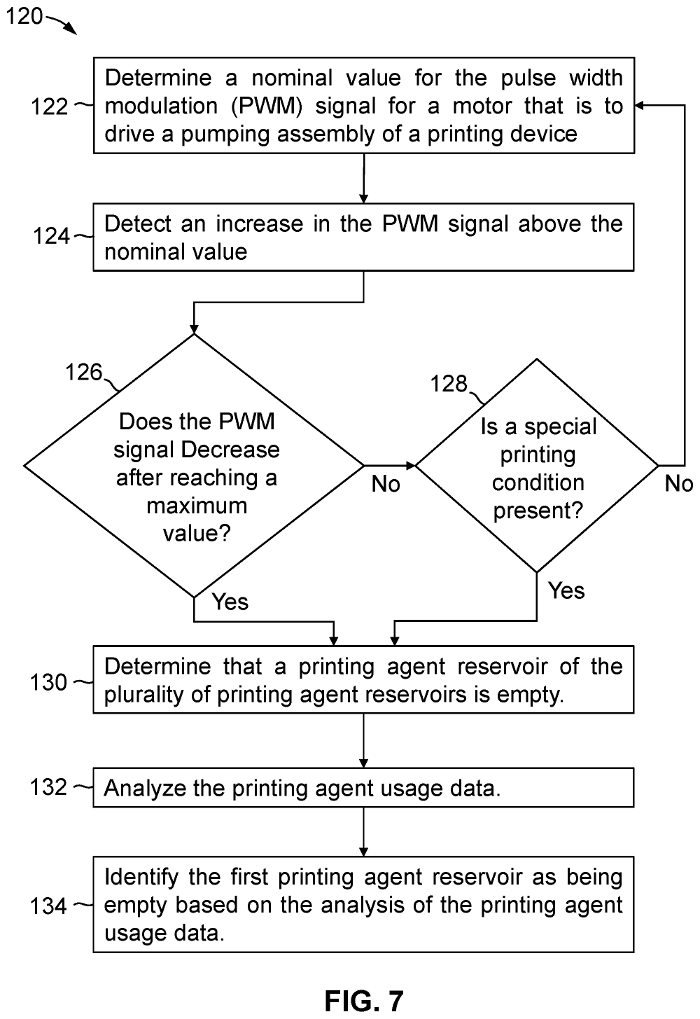

Referring now to FIG. 7, a method 120 of detecting that a printing agent reservoir of a printing device is empty is shown according to some examples. In some examples, block 110 of method 100 shown in FIG. 6 may comprise method 120. As with the method 100, in some examples, the method 120 may be practiced using the printing device 10 previously described above. Thus, in describing the features of method 120 in FIG. 7, continuing reference is made to FIGS. 1-5. However, in some examples, method 120 may be practiced with printing devices that are different from the printing device 10 described herein.

Initially, method 120 includes determining a nominal value for the pulse width modulation (PWM) signal for a motor that is to drive a pumping assembly of a printing device at block 122. For instance, as previously described in reference to FIG. 3, a nominal value P₁ of the PWM signal 72 may be found over a first time period T₁. The nominal value P₁ may be associated with pumping of printing agent from a printing agent reservoir when it has a sufficient supply and is not empty.

In addition, method 120 includes detecting an increase in the PWM signal above the nominal value at block 124. For instance, as shown in FIG. 3, an increase of the PWM signal 72 may be detected from the nominal value P₁ to a second value P₂. The increase from P₁ to P₂ may be above a threshold (e.g., P₂−P₁>Threshold) that is to distinguish PWM signal magnitude increases associated with noise or other sources other than a printing agent reservoir reaching an empty state. In some examples, the increase of the PWM signal may be compared with multiple thresholds to determine if more than one printing agent reservoir may be empty as previously described.

Next, method 120 includes determining whether the PWM signal decreases after reaching a maximum value at block 126. For instance, as shown in FIG. 3, the PWM signal 72 decreases after reaching the maximum value P₂. As previously described, the decrease may be associated with a printing agent reservoir exhausting its last available supply of printing agent so that there is no longer liquid being drawn into the corresponding pumping unit (e.g., pumping units 42, 44) of the pumping assembly 40. If the PWM signal decreases, the determination in block 126 is “yes,” and method 120 proceeds to block 130 to determine that a printing agent reservoir of the plurality of printing agent reservoirs is empty.

If, on the other hand, the PWM signal does not decrease after reaching a maximum value, the determination at block 126 is “no,” and method 120 proceeds to block 128 to further determine whether a special printing condition is present. Specifically, during a printing operation, a back pressure is normally maintained downstream of the pumping assembly 40 due to a relative over supply of printing agent to the printing assembly 60. This back pressure influences the amount of work that is completed by the motor 30 when a printing agent reservoir 20, 22 is empty, and contributes to the characteristic decrease in the PWM signal 72 from P₂ to P₃ as shown in FIG. 3. However, in some printing operations, the deposition rate of printing agent from the printing assembly 60 is increased such that the back pressure on the pumping assembly 40 is reduced or eliminated entirely. This situation may arise when printing assembly 60 is filling in a large portion of the print media 15 with printing agent. These sorts of high-flow rate printing operations may be referred to herein as a “special printing condition.” When the back pressure on the pumping assembly 40 is removed (or significantly reduced), there may not be a significant reduction in work performed by the motor when a printing agent reservoir 20, 22 reaches an empty state. In these cases, the PWM signal may substantially maintain the maximum value P₂ following the increase from P₁ to P₂. Thus, if there is no decrease in the PWM signal after reaching the maximum value such that the determination at block 126 is “no,” but there is a special printing condition present as described above such that the determination at block 128 is “yes,” then method 120 may still proceed to block 130 to determine that a printing agent reservoir of the plurality of printing agent reservoirs is empty. However, if no decrease in the PWM signal is detected (e.g., the determination of block 126 is “no”), and there is no special printing condition present (e.g., the determination of block 128 is also “no”), then it may be determined that none of the printing agent reservoirs are empty and the previously detected decrease may have been due to another issue (e.g., a clogged pumping unit, a temporary loss of flow from a printing agent reservoir, etc.).

After advancing to block 130, the method 120 may then progress to analyze the printing agent usage data at block 132 and identifying the first printing agent reservoir as being empty based on the analysis of the printing agent usage data at block 134. As previously described, the printing agent usage data may be received at block 108 of method 100 (FIG. 6) and may comprise a volume estimate of the printing agent of the printing device 10. The printing agent usage data may provide sufficient information to determine which one or ones of the printing agent reservoirs of the printing device 10 are empty and thus causing the characteristic increase(s) and decrease(s) of the PWM signal 72 at blocks 124, 126. Thus, by analyzing the printing agent usage data, the printing agent reservoirs (or multiple printing agent reservoirs) that are empty may be identified such that further remedial actions may be taken.

The examples described herein include printing devices and related methods that may detect when a printing agent reservoir is empty. In some examples, detecting that the printing agent reservoir is empty may be accomplished by monitoring a work parameter of a motor driving a pump for flowing printing agent from the printing agent reservoir. Thus, through use of the examples disclosed herein, a printing device may avoid operating with an empty printing agent reservoir, and may thereby avoid degradation of printing performance and premature wearing of the components of the printing device.

As previously described, in some examples, the systems and methods herein may be applied to determine when a printing agent reservoir is empty for printing device that is to perform additive manufacturing (e.g., a 3D printer). Thus, a “printing device” may specifically include an additive manufacturing device (and more specifically a 3D printer) in some examples.

Moreover, the system and methods herein may be utilized to determine when a reservoir of any suitable fluid or agent is empty. For instance, in some examples, the systems and methods herein may be utilized to determine when a water tank or fuel tank is empty.

In the figures, certain features and components disclosed herein may be shown exaggerated in scale or in somewhat schematic form, and some details of certain elements are omitted in the interest of clarity and conciseness. In some of the figures, in order to improve clarity and conciseness, a component or an aspect of a component may be omitted.

In the discussion above and in the claims, the terms “including” and “comprising” are used in an open-ended fashion, and thus should be interpreted to mean “including, but not limited to . . . .” Also, the term “couple” or “couples” is intended to be broad enough to encompass both indirect and direct connections. Thus, if a first device couples to a second device, that connection may be through a direct connection or through an indirect connection via other devices, components, and connections.

As used herein, including in the claims, the word “or” is used in an inclusive manner. For example, “A or B” means any of the following: “A” alone, “B” alone, or both “A” and “B.” In addition, when used herein including in the claims, the word “generally” or “substantially” means within a range of plus or minus 10% of the stated value.

The above discussion is meant to be illustrative of the principles and various examples of the present disclosure. Numerous variations and modifications will become apparent to those skilled in the art once the above disclosure is fully appreciated. It is intended that the following claims be interpreted to embrace all such variations and modifications.

What is claimed is:

1. A printing device, comprising:
a plurality of printing agent reservoirs;
a printing assembly that is to emit printing agent onto print media;
a pumping assembly fluidly coupled between the plurality of printing agent reservoirs and the printing assembly, wherein the pumping assembly includes a motor and is to transport the printing agent from the plurality of printing agent reservoirs to the printing assembly; and
a controller coupled to the motor, wherein the controller is to:
receive a work parameter of the motor;
receive printing agent usage data; and
determine that a first printing agent reservoir of the plurality of printing agent reservoirs is empty based on the work parameter and the printing agent usage data.

2. The printing device of claim 1, wherein the work parameter comprises an input voltage to the motor, and wherein the controller is to:
determine a nominal input voltage of the motor;
detect an increase above the nominal input voltage; and
determine that one of the plurality of printing agent reservoirs is empty based on the increase.

3. The printing device of claim 2, wherein the increase comprises a 1% increase or more in the nominal input voltage.

4. The printing device of claim 2, wherein the controller is to:
detect a decrease in the input voltage after the increase; and
determine that the one of the plurality of printing agent reservoirs is empty based on the increase and the decrease.

5. The printing device of claim 4, wherein the controller is to detect the increase and the decrease by monitoring a pulse width modulation of the input voltage.

6. The printing device of claim 1, wherein the printing agent usage data comprises an estimate of a volume of printing agent emitted from the printing assembly.

7. The printing device of claim 1, wherein the printing agent usage data comprises an output from a level sensor of the first printing agent reservoir.

8. The printing device of claim 7, wherein the first printing agent reservoir includes a floating stopper assembly that is to cover an outlet of the first printing agent reservoir when the first printing agent reservoir is empty.

9. A method, comprising:
actuating a pumping assembly with a motor;
transporting printing agent from a plurality of printing agent reservoirs to a printing assembly with the pumping assembly;
detecting a work parameter of the motor while transporting the printing agent;
receive printing agent usage data; and
determine that a first printing agent reservoir of the plurality of printing agent reservoirs is empty based on the work parameter and the printing agent usage data.

10. The method of claim 9, wherein the work parameter comprises an input voltage of the motor, and wherein determining that the first printing agent reservoir is empty comprises:
determining a nominal input voltage of the motor;
detecting an increase above the nominal input voltage; and
determining that one of the plurality of printing agent reservoirs is empty based on the increase.

11. The method of claim 10, wherein determining that the first printing agent reservoir is empty comprises:
detecting a decrease in the input voltage after the increase; and
determining that the one of the plurality of printing agent reservoirs is empty based on the increase and the decrease.

12. The method of claim 11, wherein detecting the increase and detecting the decrease comprises monitoring a pulse width modulation of the input voltage.

13. The method of claim 9, wherein the printing agent usage data comprises an estimate of a volume of printing agent emitted from the printing assembly.

14. The method of claim 9, wherein the printing agent usage data comprises an output from a level sensor of the first printing agent reservoir.

15. A printing device, comprising:
a first printing agent reservoir that contains a first printing agent;
a second printing agent reservoir that contains a second printing agent, wherein the second printing agent is different from the first printing agent;
a printing assembly that is to deposit the first printing agent and the second printing agent onto print media;
a pumping assembly that is to transport the first printing agent and the second printing agent to the printing assembly in parallel;
a motor that is to actuate the pumping assembly; and
a controller coupled to the motor, wherein the controller is to:
detect a change in a work parameter of the motor;
determine that one of the first printing agent reservoir and the second printing agent reservoir is empty based on the change in the work parameter;
receive printing agent usage data; and
determine that the first printing agent reservoir is empty based on the printing agent usage data.

16. The printing device of claim 15, wherein the work parameter comprises an input voltage to the motor, and wherein the controller is to detect the change in the input voltage based on a change in a pulse width modulation of the input voltage.

17. The printing device of claim 16, wherein the change in the input voltage comprises an increase in the input voltage.

18. The printing device of claim 17, wherein the increase in the input voltage comprises a 1% increase or more above a nominal input voltage.

19. The printing device of claim 17, wherein the change in the input voltage comprises a decrease after the increase.

20. The printing device of claim 15, wherein the printing agent usage data comprises an estimate of an amount of the first printing agent and an amount of the second printing agent emitted by the printing assembly.
